(19) United States
(12) Patent Application Publication
(10) Pub. No.: US 2008/0029227 A1
(43) Pub. Date: Feb. 7, 2008

(54) VEHICLE WINDOW

(76) Inventor: Karl Veldheer, Byron Center, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/462,709

(22) Filed: Aug. 6, 2006

(51) Int. Cl. E06B 7/28

(52) U.S. Cl. 160/180

(57) ABSTRACT

A removable vehicle window that has an openable panel of smaller area. The openable panel may be opened for placing mail from a vehicle to a mailbox; and for retrieving mail. A large portion of the vehicle window may be transparent so that the driver can see out of the window. The vehicle window may be secured in a manner so that the vehicle original equipment manufacturer's window may be closed, and the door may be locked while the present invention is being used.

### BACKGROUND OF THE INVENTION

This invention relates to windows for vehicles. More particularly the present invention relates to windows having a panel that can open to enable someone in the truck to deliver packages through the opening created by the open panel.

Mail delivery personnel generally drive vehicles to deliver mail. These vehicles have vehicle windows that are somewhat standard in size. The windows are much larger then normally needed to deliver the average consumer's mail. When this occurs in the winter, with cold temperatures, the mail delivery personnel have to open or descend the window to deliver the mail. This large, open area created by the open window causes the personnel to become cold, the heat from within the passenger cabin to escape, inclement weather to enter the passenger cabin of the vehicle, and the personnel to suffer from cold temperatures.

U.S. Pat. No. 4,932,454 discloses a window insert that is used to reduce the size of the opening needed to deliver mail. The '454 patent discloses a window insert that is secured by the upward force of the top edge of a moveable window 16 engaged with a panel edge 18 of the insert. Thus the insert is disposed between the window and the door frame. This does not allow the window to be closed when the insert is being used or between periods of times of use.

As can be seen, there is a need for a structure that can reduce the size of an opening required to deliver mail, and yet still allow personnel to close the window, and lock the door for security reasons. There is also a need to carry and store the vehicle window.

### SUMMARY OF THE INVENTION

One aspect of the present invention is a vehicle window, comprising: a primary portion; a panel at least partially disposed on said primary portion, said panel is capable of being opened to define an arm opening, said arm opening is capable of receiving an arm and hand of a person therethrough, whereby the vehicle window is capable of being secured to a vehicle door having an original equipment manufacturer's window, and the original equipment manufacturer's window may be closed while the vehicle window is installed on the vehicle door. Another aspect is a vehicle window, comprising: a primary portion capable of being removably secured to a door of a vehicle; an openable panel disposed on said primary portion; wherein an original equipment manufacturer's window may be in a closed position when said primary portion is secured to the door of a vehicle.

These and other features, aspects and advantages of the present invention will become better understood with reference to the following drawings, description and claims.

### BRIEF DESCRIPTION OF THE DRAWINGS

FIG. 1 is a pictorial of on exemplary embodiment of the present invention being installed on a vehicle;

FIG. 2 is a pictorial of the present invention without the vehicle;

FIG. 3 is a sectional view from FIG. 2 along line 3-3;

FIG. 4 is a sectional view from FIG. 2 along line 4-4; and

FIG. 5 is a pictorial view of one exemplary embodiment of the present invention with a carrying sack.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

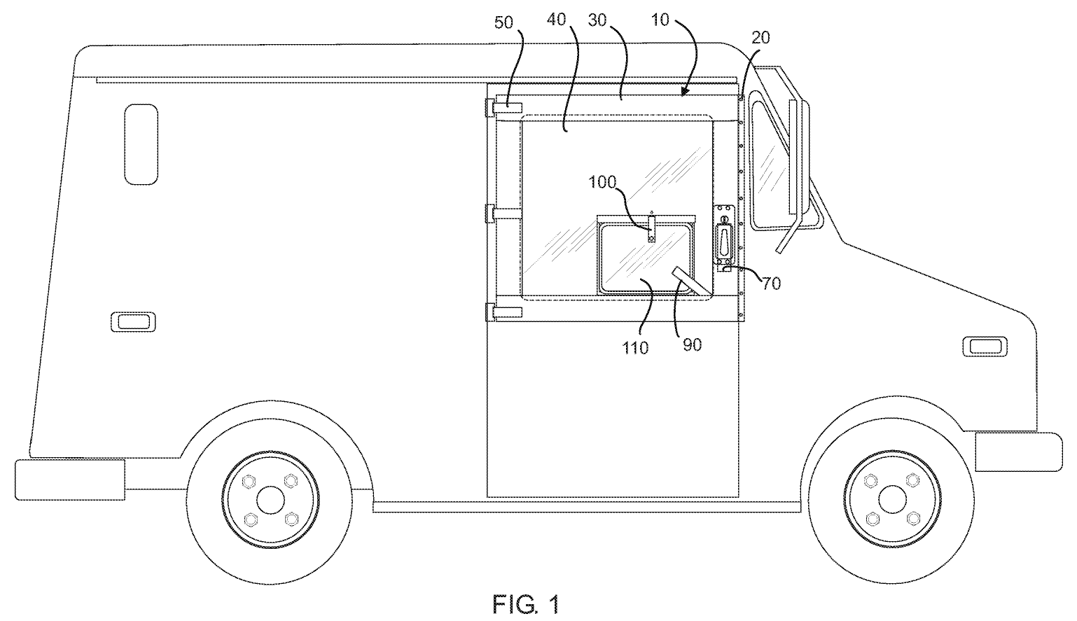

FIG. 1 illustrates a vehicle designed for roadway travel with one exemplary embodiment of the present invention installed. In one exemplary embodiment of the present invention the vehicle window 10 may be installed on the vehicle door. The vehicle window 10 may be installed immediately adjacent the standard original equipment manufacturer's window. For example, as illustrated in FIG. 1, the vehicle window 10 may be removably secured to the outside of the vehicle door. However in another embodiment, the vehicle window 10 may be placed on the inside of the vehicle door (not illustrated).

The vehicle window 10 may have a panel 110 that may be opened or closed. The panel 110 may be capable of allowing a hand carrying mail and an arm to be displaced through the opening that is created when the panel 110 is open. The panel 110 may have an area that is of less square centimeters than a portion of the window or vehicle window 10, created by, for example, a large portion 40 and a window border 30, which may be called the primary portion (being made of the large portion 40 and the window border 30). The panel 110 may have an area that is of less square centimeters that the primary portion.

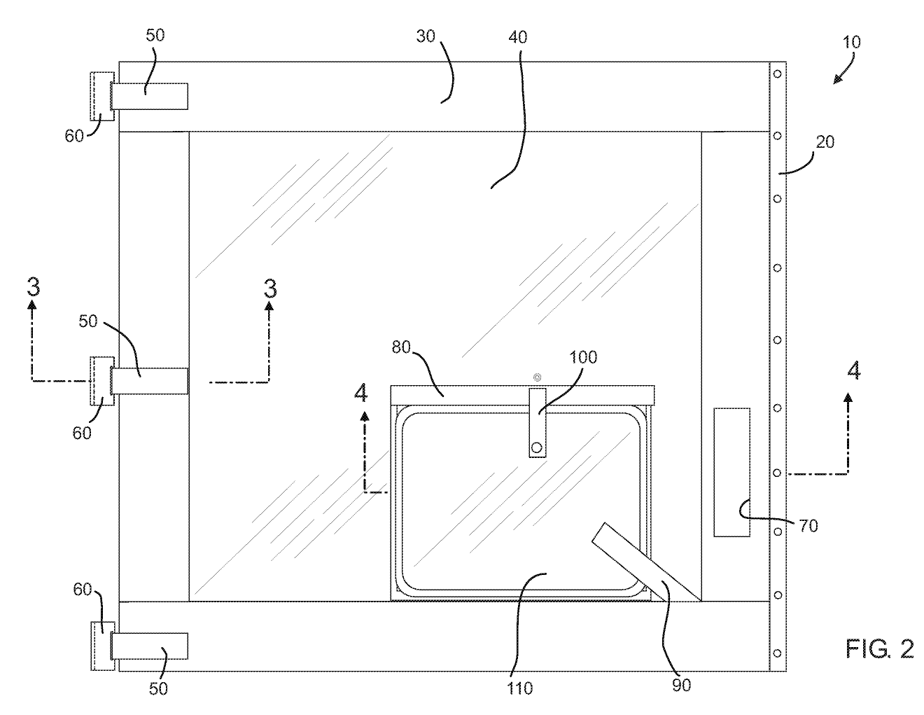

The vehicle window 10 may have a large portion 40 in which the panel 10 is disposed. The large portion 40 may be within a window border 30. The vehicle window 10 may be secured to the vehicle door by a front door portion securement member 20 that is disposed within a vehicle door cavity, chamber, or mating structure (not illustrated) at the front of the vehicle door. And a rear door portion securement member 50 adjustably and removably secured to the rear of the vehicle door. Together, the front door portion securement member 20 and the rear door portion securement member 50 may enable the vehicle window 10 to be tightly or snugly adjusted to fit to the vehicle door. The rear door portion securement member 50 may be comprised of a strap 50 and an adjustment 60. In one exemplary embodiment the adjustment 60 may be hook shaped as illustrated in FIG. 2.

The panel 110 may have a panel locking member 100 that is removably secured at a bottom end to the panel 110, and secured to the top end to a strip 80 disposed on the large portion 40. Alternatively, the panel 110 may be secured at a top end to the large portion 40. The panel 110 may also have a panel holder 90 that may be disposed at one end to the large portion 40 at another end to the panel 110. In another exemplary embodiment the panel holder 90 may be disposed at one end to the window border 30 and at another end to the panel 110.

FIG. 2 may illustrate many or all of the above features of the present invention; however in FIG. 2 the vehicle window 10 is not installed on a vehicle. As illustrated in FIG. 2, in one exemplary embodiment the vehicle window 10 may have three rear door portion securement members 50. In one exemplary embodiment the large portion 40 may be transparent so a person in the vehicle may see through the large portion 40. In one exemplary embodiment the panel 110 may be transparent so a person in the vehicle (also referred to herein as “personnel”) may see through the panel 110. In one exemplary embodiment, the primary portion, or the window border 30 may have an aperture 70 that is capable of receiving a vehicle door handle, or other protruding structure, therethrough.

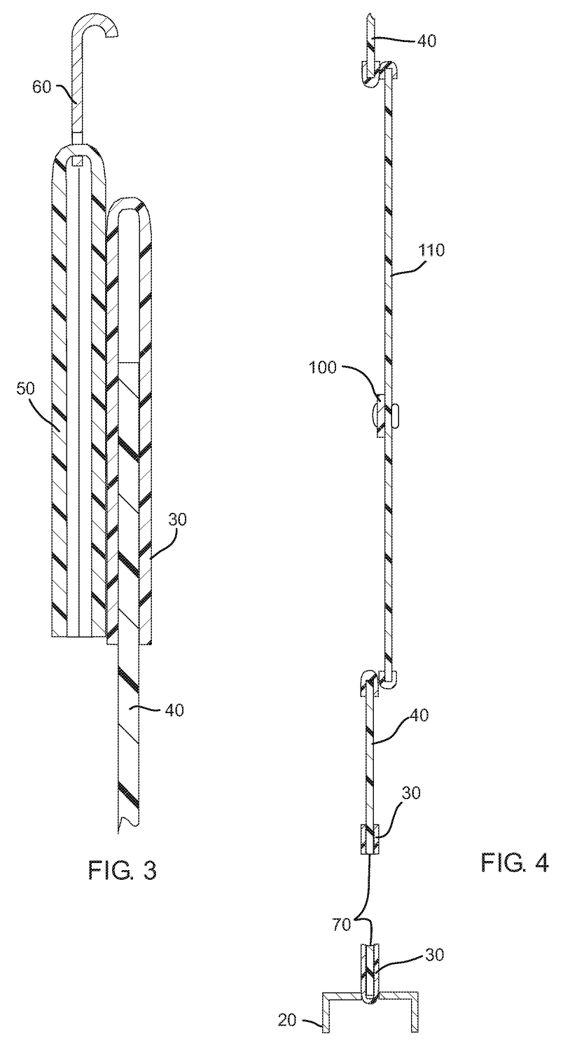

FIG. 3 illustrates a sectional view from FIG. 2 along section line 3. Section line 3 extends through the adjustment 60, the rear door portion securement member 50, the window border 30, and the large portion 40.

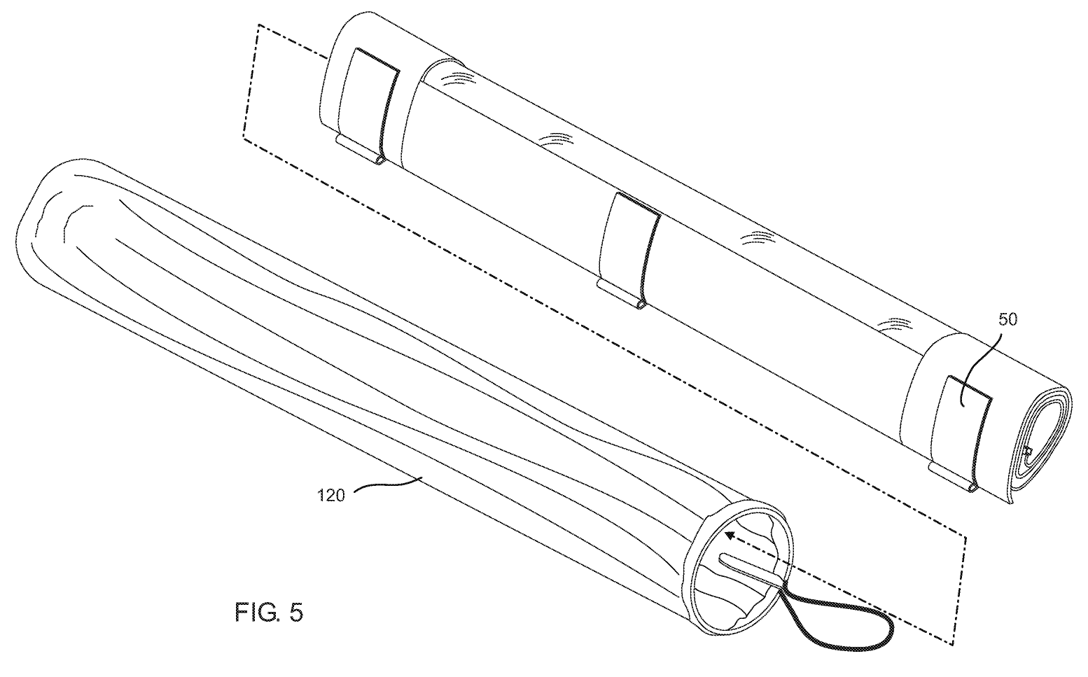

FIG. 4 illustrates a sectional view from FIG. 2 along section line 4. Section line 4 extends through the large portion 40, the panel 110, the window border 30, the aperture 70, and the front door portion securement member 20.

FIG. 5 illustrates a case 120 that is capable of receiving the vehicle window 10 for storage and transport. In one exemplary embodiment the vehicle window 10 may be of pliable material so that it can be rolled up as illustrated in FIG. 5. In one exemplary embodiment the 120 also has a draw string 130.

In one exemplary embodiment the vehicle window 10 may be comprised of waterproof material. In one exemplary embodiment the vehicle window 10 may be comprised of water-resistant material.

In one exemplary embodiment the panel 110 has a length (measured along the horizontal) of about 17 inches and a height (vertical) of 12.5 inches. In one exemplary embodiment the panel has an area of about 212.5 square inches.

In one exemplary embodiment the vehicle window 10 has a height (vertical) of about 39 inches and a length (horizontal) of about 42 inches. In one exemplary embodiment the vehicle window 10 has an area of 1638 square inches. In one exemplary embodiment the aperture 70 may have a length (horizontal) of about 2.5 inches, and a height (vertical) of about 8 inches; and thus an area of about 20 square inches.

In one exemplary embodiment the large portion 40 has a length (horizontal) of about 32.5 inches and a height (vertical) of about 29.5 inches. In one exemplary embodiment the large portion 40 has an area of about 958.75 square inches.

It should be understood, of course, that the foregoing relates to exemplary embodiments of the invention and that modifications may be made without departing from the spirit and scope of the invention as set forth in the following claims.

I claim:

1. A vehicle window, comprising:
a primary portion;
a panel at least partially disposed on said primary portion, said panel is capable of being opened to define an arm opening, said arm opening is capable of receiving an arm and hand of a person therethrough,
whereby the vehicle window is capable of being secured to a vehicle door having an original equipment manufacturer's window, and the original equipment manufacturer's window may be closed while the vehicle window is installed on the vehicle door.

2. The vehicle window of claim 1, wherein said primary portion has an area of about 1638 square inches.

3. The vehicle window of claim 1, wherein said panel has an area of about 212.5 inches.

4. The vehicle window of claim 1, wherein said primary portion is made of a large portion and a window border.

5. The vehicle window of claim 1, wherein said panel primary portion has an area that is transparent.

6. The vehicle window of claim 1, wherein the vehicle window is capable of being secured to a vehicle door via a front door portion securement member.

7. The vehicle window of claim 1, wherein the vehicle window is capable of being secured to a vehicle door via a rear door portion securement member.

8. The vehicle window of claim 4, wherein said window border surrounds said large portion.

9. The vehicle window of claim 6, wherein said front door portion securement member is rigid.

10. The vehicle window of claim 7, wherein said rear door portion securement member is made of a strap and a hook.

11. The vehicle window of claim 1, further comprising a panel locking member that is capable of keeping an upper part of the panel closed, and further comprising a panel holder to enable a front part of the panel to be held close to said large portion to prevent flapping.

12. A vehicle window, comprising:
a primary portion capable of being removably secured to a door of a vehicle;
an openable panel disposed on said primary portion;
wherein an original equipment manufacturer's window may be in a closed position when said primary portion is secured to the door of a vehicle.

13. The vehicle window of claim 12, further comprising:
a front door portion securement member that is capable of being removably engaged with a front door portion of the vehicle.

14. The vehicle window of claim 12, further comprising:
a front door portion securement member that is capable of being slidably removably engaged to a front door portion of the vehicle.

15. The vehicle window of claim 12, further comprising:
a rear door portion securement member that is capable of being removably secured to a rear door portion of the vehicle.

16. The vehicle window of claim 12, wherein said primary portion has a transparent part.

17. The vehicle window of claim 12, wherein said panel has a transparent part.

18. The vehicle window of claim 12, further comprising an aperture that is capable of receiving a door handle therethrough.

19. The vehicle window of claim 12, further comprising a case to carry and transport the vehicle window.
